(19) United States
(12) Patent Application Publication
(10) Pub. No.: US 2007/0006315 A1
(43) Pub. Date: Jan. 4, 2007

(54) Network asset security risk surface assessment apparatus and method

(76) Inventor: Firas Bushnaq, Laguna Beach, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/477,270

(22) Filed: Jun. 29, 2006

Related U.S. Application Data
(60) Provisional application No. 60/695,960, filed on Jul. 1, 2005.

(51) Int. Cl. G06F 11/00

(52) U.S. Cl. 726/25

(57) ABSTRACT

In accordance with at least one embodiment of the present invention, a method of computing a risk surface vector, comprises the operations of gathering raw assessments, forming single assessments, creating asset values, scaling by asset values, calculating higher-level assessment formulas per asset, creating asset-value weighted averages for aggregate groups, and calculating a final high-level risk surface value.

### CROSS-REFERENCE TO RELATED APPLICATION

This application claims priority to Patent Application No. 60/695,960, filed on Jul. 1, 2005, in the United States Patent and Trademark Office, the entire content of which is hereby incorporated by reference.

### TECHNICAL FIELD

The field of invention relates generally to network security, and more particularly to providing a network asset security risk assessment.

### BACKGROUND

Computer network assets, such as servers and host machines, are increasingly under attack. Viruses, worms, and the individuals who spawn them are also finding greater opportunity for extracting and exploiting illicitly obtained user information and corporate data. While these attacks are increasing in frequency and complexity, some network security managers have been required to spend an exponentially larger amount of time and financial resources to combat these attacks and in remediation. An area of concern for these network managers is the difficulty in ascertaining, characterizing, and quantifying risk to their network assets. Therefore, there remains a need in the art for an apparatus and method to provide network asset risk assessment.

### BRIEF DESCRIPTION OF THE DRAWINGS

FIG. 1 shows a risk surface graphical element, in accordance with an embodiment of the present invention.

FIG. 2 shows a risk surface tile for an aggregated group of assets, in accordance with an embodiment of the present invention.

FIG. 3 shows a computer system that can be configured to execute a predetermined set of instructions to perform the computation, display, and evaluation of a risk surface graphical element and a risk surface tile, in accordance with an embodiment of the present invention.

FIG. 4 shows a comparison pane including a plurality of risk surface tiles, in accordance with an embodiment of the present invention.

FIG. 5 shows a Network Asset Security Risk Surface Assessment Flow, in accordance with an embodiment of the present invention.

FIG. 6 shows a graph indicating the relationship between criticality values and asset values, in accordance with an embodiment of the present invention.

FIG. 7 shows a table of resolved criticality values for the same collection of different value assets using different exponent bases, in accordance with an embodiment of the present invention.

FIG. 8 shows a risk surface graphical element, in accordance with an embodiment of the present invention.

FIG. 9 shows a comparison pane including a plurality of risk surface tiles, in accordance with an embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

By analogy, a computer network resource such as a server, host machine, or other network device, may be viewed as a castle containing a valuable treasure. The castle walls may protect an inner sanctum containing gold or something of value. An individual, or an army, may attempt to breach the castle walls in order to enter the inner sanctum, to steal the gold, and/or to disturb the inhabitants of the castle. Using this analogy, several metrics may be applied to gauge the risk to the castle and treasure including: Exposure, Threats, Attacks, and Vulnerabilities.

In this context, the first metric, Exposure, relates to the possibility of loss based on various castle attributes including the castle Periphery and Lack-of-Protection for the castle. Periphery is a measure of the extent which the castle walls and openings may be attacked (e.g. the effective length and height of the walls). Lack-of-Protection is a measure of how well or how poorly the castle periphery is protected (e.g. by moats, guards, gates, etc.). The second metric, Threat, relates to a measure of any lurking individuals or armies on the hills surrounding the castle, who may be priming for attack. The third metric, Attacks, relates to a measure of the actual arrows and bombs and breach attempts on the walls and inner sanctum. Finally, the fourth metric, Vulnerabilities, relates to a measure of how easy it is for the inner sanctum to be breached and used to gain access to the gold. If the castle is within an empire or kingdom, a high-level factor, Asset Value, may be assigned to measure how valuable or important the castle and inner sanctum are in terms of value (e.g. amount of gold or other valuables) and strategic importance of the castle to the empire. An alternate term for Asset Value could be Criticality.

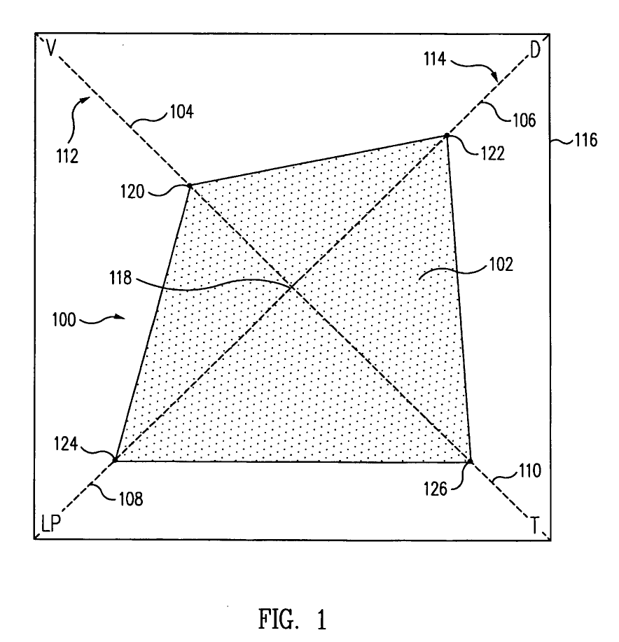

FIG. 1 shows a risk surface graphical element 100, also termed a risk surface 100, comprising a two-dimensional representation of risk in accordance with an embodiment of the present invention. In general terms, risk may be defined as any possible or actual compromise of a network asset connected to a communications network such as the Internet. Risk surface 100 has a risk surface area 102 calculated as the area subtended by four normalized vectors (104, 106, 108, and 110) defining different risk factor areas located on a pair of diagonals (112, and 114) drawn between the vertices of a square boundary 116. In this manner, risk surface area 102 describes a quadrilateral or “diamond” form. The risk surface area 102, corresponding to a risk computation, may be displayed in various other formats including a rectangle, a cube, and one or more area charts.

A first normalized vector 104 corresponds to a Vulnerabilities (V) area, a second normalized vector 106 corresponds to an Attacks (D) or alternatively (A) area, a third normalized vector 108 corresponds to an Exposure (Lack-of-Protection, or LP) or alternatively (E) area, while a fourth normalized vector 110 corresponds to a Threat (T) area. A vertex 118 corresponds to the intersection of all four normalized vectors (104, 106, 108, and 110) where each normalized vector has a zero length value comprising a zero point. First diagonal 112 includes first normalized vector 104 and fourth normalized vector 110, where first normalized vector 104 is opposite in direction to fourth normalized vector 110 about zero point 118. Second diagonal 114 includes second normalized vector 106 and third normalized vector 108, where second normalized vector 106 is opposite in direction to third normalized vector 108 about zero point 118.

Risk surface 100 intersects each normalized vector at a predetermined point corresponding to a normalized vector value along each normalized vector (104, 106, 108, and 110). In this manner, surface 100 intersects first normalized vector 104 at a first normalized vector value 120 corresponding to a Vulnerabilities vector length value. Similarly, surface 100 intersects second normalized vector 106 at a second normalized vector value 122 corresponding to an Attacks vector length value. Surface 100 intersects third normalized vector 108 at a third normalized vector value 124 corresponding to an Exposure vector length value. Finally, surface 100 intersects fourth normalized vector 110 at a fourth normalized vector value 126 corresponding to a Threats vector length value. First diagonal 112 is not parallel to and may be orthogonal to second diagonal 114 so that when at least two adjacent normalized vector values (120, 122, 124, and 126) have a non-zero length value, a non-zero area value for risk surface area 102 will result. The geometric disposition of normalized vector values (120, 122, 124, and 126) can describe a risk surface 100 for a specific network asset or group of assets. Risk surface 100 can be reproduced in any fixed medium including a computer printout or book, or any temporal medium including a graphic user interface (GUI) such as a computer display screen or a projected image.

As shown in FIG. 1, there are four main vectors: Vulnerability (V), Attacks (D), Exposure (LP), and Threat Level (T). Criticality does not have its own vector axis, instead criticality is incorporated via asset-value scaling of assessments within the vectors themselves. All asset values may be exponentially scaled user criticality values, using a ‘power’ of 1.5 which is ‘flatter’ than the previous natural log or 2 powers used. Other exponent values and bases may be used. A thresholding method may be used to better account for vector aggregates (multiple assets). Where no actual attack data is available, attack data may be inferred as will be discussed below. Aggregate (multiple asset) values use averages that weight according to asset value. An optional indicator, such as a diamond or other symbol, may be used to identify <n> devices above a maximum value.

Risk may be calculated based on the four high-level vectors (V, D, LP, T). In this manner, Risk may be defined as the product of the magnitudes of the composite vectors and expressed as:

Risk=Vulnerability×Attacks×Threat×Exposure

In this case, Vulnerability (V) is a measure of issues that may indicate actual or potential problems. Vulnerability may be measured and reported by a network security scanner. One exemplary network security scanner is the RETINA (TM) product supplied by eEye Digital Security with an address of 1 Columbia, Aliso Viejo, Calif., 92656. Attacks (D) is a measure of actual attacks and dangers. Attacks may be measured and reported by an intrusion detection and shielding application that may be used to detect, analyze, and/or prevent network-based attacks. One exemplary intrusion detection and shielding application is the BLINK (TM) product supplied by eEye Digital Security identified above. Exposure (E) is an accounting of extent and openness to attack and measures the magnitude of the periphery (size of the virtual border) there is to be protected and how well or poorly it is being protected. Finally, Threat (T) is a measure of lurking or impending danger and may alternatively be referred to as a Threat Climate Defense Condition (Defcon).

Since criticality is not present as a main vector, criticality may instead be factored into each vector along-the-way by scaling the raw assessments (Vulnerability, Threat, etc.) by the asset value. Vulnerabilities and Attacks may be viewed as measures of actual problems, while Threat and Exposure may be viewed as exacerbating factors that may make the actual problems worse. Geometrically, Vulnerability and Attacks may be aligned on one axis, while Threat and Exposure on the orthogonal axis. For example, as the Threat (T) vector increases the effect of both V and A on the total area increases. The result is that the area subtended by the vectors increases based on the effect of one axis on the other, as is expected. A particular vulnerability could result in a higher risk if the machine at risk is more important or less protected.

FIG. 1 shows a risk surface area 102 that may be calculated as the area subtended by the four normalized vectors (having values between 0-9) drawn out along the diagonals (112, 114) in a square 116. The color, size, and the geometrical shape of the tile 102 may communicate a risk level and/or a risk profile including the timeliness of the risk data. A red color, for example, may communicate highest risk, yellow may communicate medium risk, and green may communicate low risk, for example. Further, a luminosity level (e.g. brightness) may be used to communicate risk where a higher light intensity may convey a higher significance than a lower light intensity. Alternatively, a brighter color may indicate more current or timely information, while a duller color may indicate historical or reference information, for example. Other colors and intensity levels may be used having different meanings.

The area covered by the tile 102 may be stated in equation form as:

(V+A)*T/2+(V+A)*E/2=(V+A)*(T+E)/2

Using a minimum vector length of 0 and a maximum vector length of 9, this would yield a minimum risk for a device or group of devices as 0, and the maximum risk for a device or group of devices as 18*18/2=162. If the total Risk values are normalized to between 0 and 9 as well, the Risk formula can be modified as:

Rn=(((V+A)*(T+E))/2)*(9/((18*18)/2))=((V+A)*(T+E))/36

For example, if all vectors are 9, R=(9+9)*(9+9)/36=9. Alternatively, instead of dividing by 9, a different view may be used that may be used to skew one or more vectors.

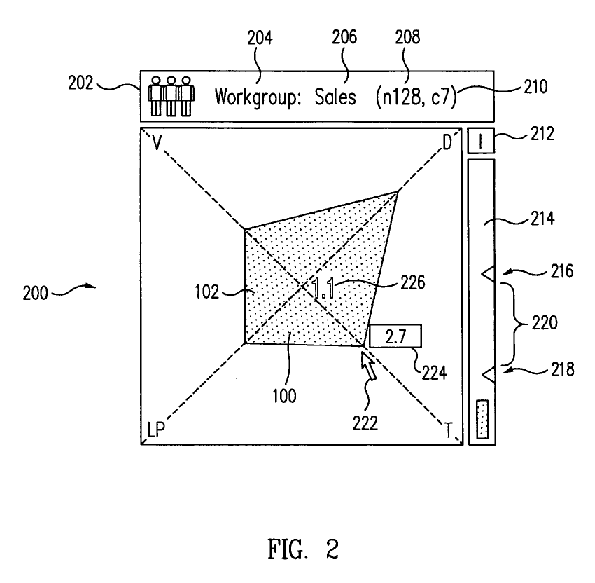

FIG. 2 shows a risk surface tile 200 element for an aggregated group of assets (not shown). Risk surface tile 200 is a graphical representation that can include a risk surface graphical element 100, an attribute type icon 202 or title bar, an attribute type field 204, and an attribute value or group identifier 206 where attribute type icon can include a number of assets (nassets) in the group 208 and an aggregated criticality factor 210. Risk surface tile 200 can include an information button 212 that can be used to access a detailed data breakdown, for example. A vertically oriented magnitude symbol, or “thermometer” 214 can graphically represent a risk value along with a user defined upper bound 216 and lower bound 218 describing a user comfort zone 220 where the risk value is considered to be acceptable. Alternatively, another type or orientation of the magnitude symbol may be used. Tracking of the user comfort zone may allow detection of an emerging condition prompting an alert.

A cursor 222 corresponding to the position of a pointing unit (not shown) may be superimposed over tile 200 in order to display additional information. For example, when cursor 222 is located over a normalized vector, in a mouseover operation, a vector length value 224 may be represented. Finally, a risk normalized numerical value 226 may be represented as superimposed over risk surface 100 in order to provide a numerical representation of the risk surface area 102. The described elements or their equivalents may be represented in a different order or arrangement, where some or all of the described elements are present. A geometrical risk surface tile depiction could be used in various computer applications to show a risk surface for a specific asset or group of assets.

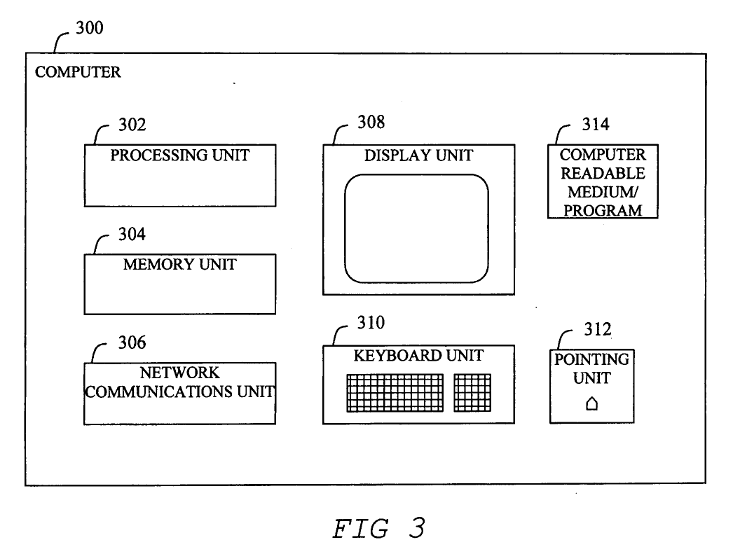

FIG. 3 shows a computer system 300 that can be configured to execute a predetermined set of instructions to perform the computation, display, and evaluation of a risk surface graphical element 100 and a risk surface tile 200, in accordance with an embodiment of the present invention. Computer system 300 may be a suitably programmed microcomputer includes a processing unit 302, a memory unit 304 for storing data and instructions, a network communications unit 306 for communicating with other network devices on a network, a display unit 308 for providing a visual display to a user, a keyboard unit 310 for receiving textual input from a user, a pointing unit 312 (e.g. a mouse) for receiving spatial input from a user in a graphical user interface (GUI), and a computer readable medium 314 or program on with is stored a computer program (readable by processor 302) for executing instructions according to one or more embodiments of the present invention. Processing unit 302 may fetch, decode, and execute instructions from a computer program or application stored in memory unit 304 and/or computer readable medium 314. The communications network may conform to a standard communications protocol such as the Transfer Control Protocol/Internet Protocol (TCP/IP), and may include a hierarchy of connectivity comprising a Local Area Network (LAN) connected to a Wide Area Network (WAN), for example. By orienting a pointing unit 312 cursor or icon over a particular graphical feature, additional information may be displayed. This may be termed mouseover data which is displayed when the cursor or icon is in proximity to a mouseover sensitive graphical feature. Pointing unit 312 may include a mouse button for use in entering information in a point-and-click fashion. Further, an information button or pull-down menu may be activated. A detailed breakdown of a particular calculation may be displayed in the same or a different window/layer using any of the mouseover, pull-down, or point-and-click methods.

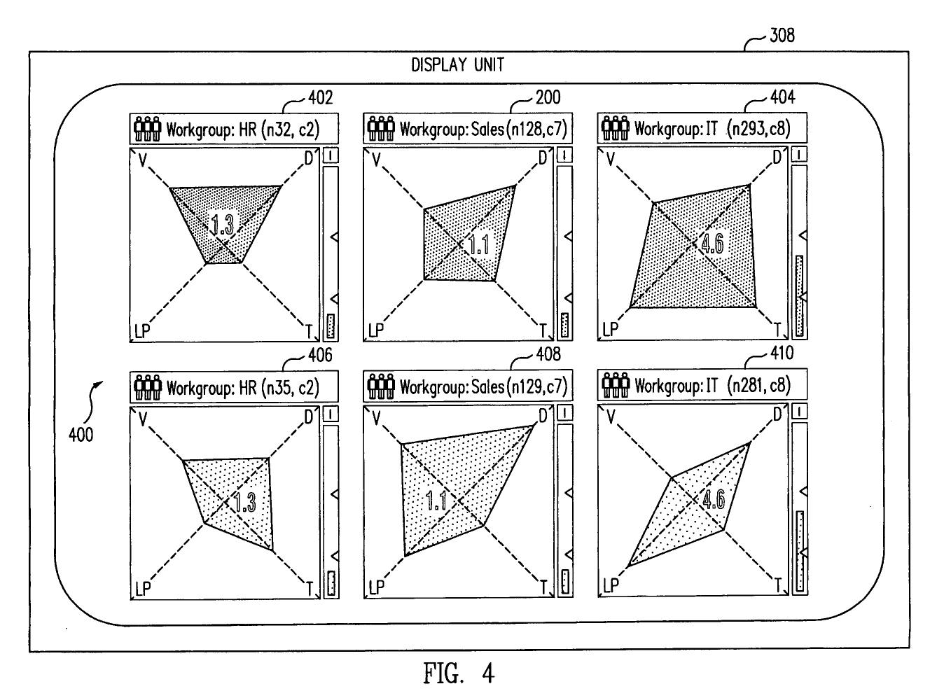

FIG. 4 shows a comparison pane 400 including a plurality of risk surface tiles (200, 402, 404, 406, 408, and 410) where the position of each tile conveys temporal or grouping information. In this example, tiles positioned horizontally correspond to different groups at substantially the same time within a predetermined reporting period, while tiles positioned vertically correspond to the same groups at different times. More specifically, tile 402 may correspond to the HR Workgroup at a first time, while tile 406 may correspond to the HR Workgroup at a second time that is different from the first time. Conversely, tile 402 and tile 200 correspond to the HR Workgroup and Sales Workgroup at substantially the same time comprising concurrent risk assessment data. Comparison pane 400 may be displayed using a browser program or application, such as a web-browser, running on processing unit 302. The number of risk surface tiles is not limited to that shown.

The Risk Surface depictions and tiles facilitate an intuitive visual Risk comparison of different groups (shown horizontally) at a particular point in time, and comparisons of the same groups at different times (shown vertically). In one alternative, historical data may use neutral colors for the risk surface, as the risk values shown are not current, where only the current risk values are shown in vivid colors. In one embodiment, the colors assigned to the tile in frame 200 could be bright orange, the color assigned to the tile in frame 402 could be bright yellow, and the color assigned to the tile 404 could be bright red. Similarly, the color assigned to the tile in frame 406 could be a muted red, while the colors assigned to the tiles in windows 408 and 410 could be bright red. In yet another alternative, the color of a tile may convey redundant information in the sense of communicating a level of risk, where an assigned color reflects a level of risk, while the size or geometry of the tile already convey a corresponding risk level. Having a plurality of colors may help a user to more easily or more quickly identify a risk issue.

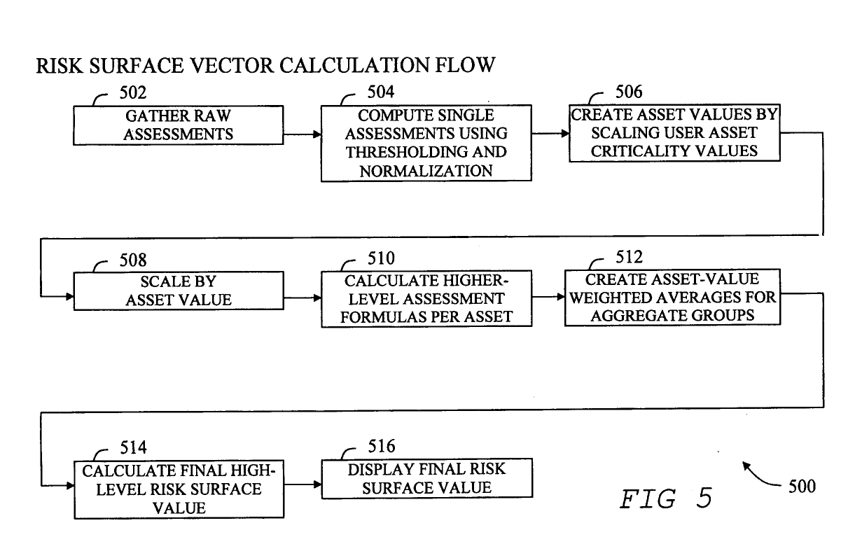

FIG. 5 shows a Network Asset Security Risk Surface Assessment Flow 500, in accordance with an embodiment of the present invention. Flow 500 may include gathering raw assessments in operation 502, computing single assessments by thresholding and normalizing in operation 504, creating asset values by scaling user asset criticality values in operation 506, scaling by asset value in operation 508, calculating higher-level assessment formulas per asset in operation 510, creating asset-value weighted averages for aggregate groups in operation 512, calculating final high-level risk surface value in operation 514, and displaying the final risk surface value in operation 516. Aggregate groups may also be meaningfully partitioned.

Where (m) denotes ‘of machine/asset m’, operation 502 may include the following gathering and/or calculating aspects to determine the following ‘raw’ assessments over a given period-of-time:

Raw-Assessment-A: (V) Vulnerability Audit Severities (m) 1 . . . n (gather)

Raw-Assessment-B: (D) Attack Severities (m) 1 . . . n (gather)

Raw-Assessment-C: (T) Threat Level (m) (gather and calculate)

Raw-Assessment-D: (P) Periphery (m) (gather and calculate).

Raw-Assessment-E: (L) Lack-of-Protection (m) (gather and calculate)

An intrusion detection and shielding application may be used to detect, analyze, and/or prevent network-based attacks. One exemplary intrusion detection and shielding application is the BLINK (TM) product supplied by eEye Digital Security identified above. If an intrusion detection and shielding application is not used, and there is no actual attack data, then estimated attack values may be inferred by using machine type and situation to access a database lookup from a separate table.

Raw-Assessment-C may include the following Threat Level calculation: Threat Level=Threat Climate Defcon (Defense Condition, or Alert Level), where: Threat Climate Defcon=userRatioTI1*ThreatIndex1+userRatioTI2*ThreatIndex2 . . . +userRatioTIn*ThreatIndexn, and userRatioTI1+userRatioTI2+ . . . userRatioTIn=1 and are user defined values.

The series ThreatIndex1 . . . ThreatIndexn may be obtained from the various ThreatClimate sources and each may be pre-normalized to a value between 0 and 9. All indices may be used generally and need not be specific to particular assets or services. However, if ThreatIndexes are made more asset-specific, the associated formulas will take this into account.

Raw-Assessment-D may include the following Periphery calculation:

Periphery(m)=userRatioPorts×9×(nPorts/maxPorts)+userRatioShares×9×(nShares/maxShares)+userRatioServices×9×(nServices/maxServices)+userRatioUSers×9×(nUsers/maxUsers)

Where userRatioPorts+userRatioShares+userRatioServices +userRatioUsers=1. The values for maxPorts . . . maxUsers may be constants either across-the-board or specific to the type of machine/usage and loaded via a lookup table. All n/max numbers may be clamped between 0 and 1 (i.e. no n/max value above 1). The ‘max’ values may be asset-type-specific in the sense that a server may have a different ‘representative’ number of Services or Shares or Ports or Users compared to a generic Personal Computer (PC).

Raw-Assessment-E may include the following Lack-of-Protection calculation:

LackofProtection=9−(9/nFactors )* (userRatioLP1*AntivirusRating+userRatioLP2*FirewallHostRating +userRatioLP3*FirewallDMZRating+userRatioLP4*OSSPHotfixRating +userRatioLP5*ScanRecencyRating+userRatioLP6*ScanCompletenessRating)

In the above question, the term nFactors is a constant and corresponds to the number of protection factors that are used (i.e. nFactors=6). Further terms are defined as AntivirusRating=1 if antivirus is present (0 if not), FirewallHostRating=1 max (0 min), FirewallDMZRating=1 max (0 min), OSSPHotfixRating=1 max (0 min), ScanRecencyRating=1 max (0 min), and ScanCompletenessRating=1 max (0 min). The sum of userRatioLP1+userRatioLP2 . . +userRatioLPn=1 (which are user defined values). In this example, all rating values must be normalized between 0 and MAX, where MAX may equal 9. The variability of the userRatioLP values allows for the configuration of the relative importance of the various protection factors. In this example, they must sum to 1.

According to flow 500, computing single assessments by thresholding and normalizing in operation 504 for multiple audit and attack severities per asset may include a ‘threshold’ merge each asset's multiple values to create a summation value per asset to provide:

Single-Assessment-A: (V) Vulnerability Audit Severity (m)

Single-Assessment-B: (D) Attack Severity (m)

Single-Assessment-C: (T) Threat Level (m)

Single-Assessment-D: (P) Periphery (m)

Single-Assessment-E: (L) LackofProtection (m)

In detail, the single assessment methodology includes starting with the h the highest kind of vulnerabilities, and assigning a base value (e.g. H=7, M=5, L=3). Once the base value is assigned, up to 2 points are added based on the total number of vulnerabilities of that type. Finally, another factor of up to 0.5 is added based on the total vulnerabilities of the next lower type. Heavy use of thresholding may prevent a washout or dilution of the average values. The following conditional structure may be used to determine the vulnerability values:

If H>0 then V(Machine)=[V(H)=([H/2.5]₀²+7)+V_{add}(M)=([M/20]₀^{0.5})]

Else if M>0 then V(Machine)=[V(M)=([M/5]₀²+5)+V_{add}(L)=([L/30]₀^{0.5})]

Else if L>0 then V(Machine)=[V(L)=([L/7.5]₀²+3)]

Else 0.

In one example, for a machine that has three high risk and ten medium risk vulnerabilities, the V(machine) is calculated with a base of 7+1.2 (3/2.5=1.2) for the high risk, to which is added 0.5 for the ten medium risk, for a total numeric risk value of 8.7 units.

According to flow 500, the operation of creating asset values by scaling user asset criticality values in operation 506 may include for each asset the calculation of a 0-9 normalized Asset Value via an exponential mapping from user-defined asset Criticality. The idea is to include a subjective valuation of what a user may consider an asset is worth (in a linear 0-9 sense) and modify that adjust for these purposes. In more detail, the user criticality values may be set per asset at values 0-9 that may be non-linearly scaled.

Using the formula y=exp(x), which is the inverse of the natural logarithm—in other words it is the number ‘e’ (2.718282) raised to the power of the criticality. This progression is used which reaches a peak of a little over 8000 at risk 9. Alternatively, the exponential formula may be ‘flattened’ a bit. In yet another alternative, this progression can be easily customized by increasing the size of the base—slowly. At 3.5 the peak is already ˜78816. With the progression below 1 value 9 asset is “worth” almost 3000 value 1 assets.

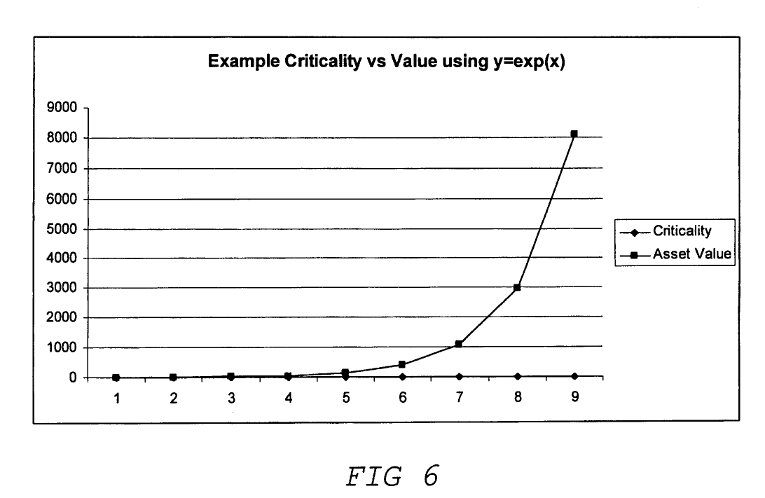

FIG. 6 shows a graph indicating the relationship between criticality values and asset values, in accordance with an embodiment of the present invention. The value weighted surface criticality may resolve as:

$$\frac{{\sum }_{m = 1}^{N} ( C ( m ) ⨯ AV ( m ) )}{{\sum }_{m = 1}^{N} AV ( m )}$$

Which may also be expressed as:

$$\frac{{\sum }_{m = 1}^{N} [ C ( m ) ⨯ exp ( C ( m ) ) ]}{{\sum }_{m = 1}^{N} exp ( C ( m ) )}$$

Adjusting the exponent size may “zero in” on a more refined value while allowing the option of user customization. In essence, the bigger the network the bigger the recommended weighting to ensure the critical assets weight the surface as the customer desires.

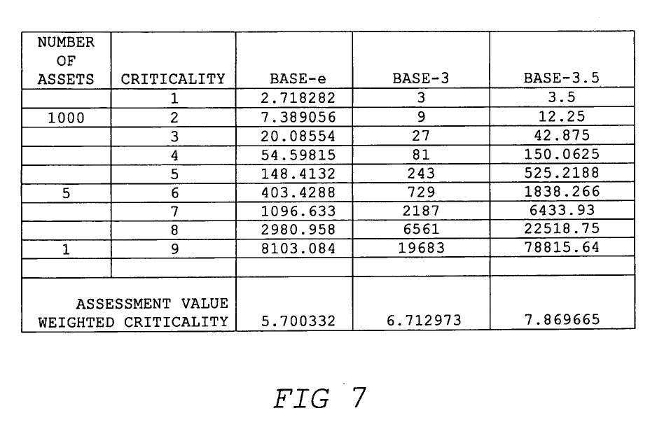

FIG. 7 shows a table of resolved criticality values for the same collection of different value assets using different exponent bases, in accordance with an embodiment of the present invention. In this example, the resolved criticality (C) values for the same collection of different value assets are shown using different exponent bases.

The criticality may be scaled based on qualitative business importance. Preferably, various business sub-processes could be specified where the criticality is automatically scaled based on the importance to that process. For a Billing process, all the criticalities could reflect the asset importance to Billing. For a Total view, the criticalities could change to reflect the global asset importance. The processes could then be mapped in a “fishbone” style critical path, which would translate the criticality of any system to any process on the critical path using a weighted tree data-structure. This would allow for the start of a kind of survivability modeling by process. Regarding the topic of survivability modeling, a paper by Zhixing Gao et al. titled “Survivability Assessment: Modeling Dependencies in Information Systems” was published in the Proceedings of the Information Survivability Workshop (ISW 2002), Vancouver, BC, March 2002. A Criticality rating of 1 would likely be of minor importance, like one single workstation. On the other hand, a rating of 9 would likely be considered truly business or mission critical—if this asset is compromised or downed the entire business or mission stops. All other criticality ratings may have intermediate effects which may include a total shutdown for a portion of the business or mission.

According to flow 500, the operation of scaling by asset value in operation 508, may include for each asset the use of its Asset Value (AV) to scale its summary assessments (Audit severity, Attack severity, etc.), where the Assessment Scaled (m)=Assessment Raw (m)*((Asset Value (m)/9)+0.5), and the maximum scaled assessment value is limited to 9. One result of this scaling is to exaggerate the assessment if its Asset Value is greater than 4.5 and to demote its assessment if its Asset Value is less than 4.5, for example. Other threshold or decision values may also be used.

According to flow 500, the operation of calculating higher-level assessment formulas per asset in operation 510, may include for each asset, the use the higher level formulas for Vulnerability, Threat, Defcon, and/or Lack-of-Protection. In this case,

V(m)=Vulnerability(m)=Audit Severity(m)=as is

A(m)=Attacks(m)=Attacks Severity(m)=as is

T(m)=Threat Level(m)=as is

E(m)=userRatioE1*Periphery(m)+userRatioE2*Lack-of-Protection(m)

After this, the calculated values are ready for display on an individual asset. The userRatioE1 and userRatioE2 should sum to 1, and should allow a user to configure the relative weighting of Periphery and LackofProtection in Exposure.

According to flow 500, the operation of creating asset-value weighted averages for aggregate groups in operation 512, may include for each group of assets the creation of weighted averages of the higher-level formula values, and weighting by Asset Value to give more prominence to the important machines in a group. Where (g) ‘denotes of group g’, this process should be accomplished for each of the four main assessment vectors:

V (g)=weighted average of Vulnerability (m) for all assets m in group

A (g)=weighted average of Attack (m) for all assets m in group

T (g)=weighted average of Threat Level (m) for all assets m in group

E (g)=weighted average of Exposure (m) for all assets m in group

The detailed formulas for calculating the weighted averages for Assessment Values include:

$$Vulnerability ( g ) = \frac{{\sum }_{m = 1}^{N} ( Vulnerability ( m ) ⨯ Asset\_Value ( m ) )}{{\sum }_{m = 1}^{N} Asset\_Value ( m )}$$

$$Threat ( g ) = \frac{{\sum }_{m = 1}^{N} ( Threat ( m ) ⨯ Asset\_Value ( m ) )}{{\sum }_{m = 1}^{N} Asset\_Value ( m )}$$

$$LevelofProtection ( g ) = \frac{{\sum }_{m = 1}^{N} ( LevelofProtection ( m ) ⨯ Asset\_Value ( m ) )}{{\sum }_{m = 1}^{N} Asset\_Value ( m )}$$

$$Defcon ( g ) = \frac{{\sum }_{m = 1}^{N} ( Defcon ( m ) ⨯ Asset\_Value ( m ) )}{{\sum }_{m = 1}^{N} Asset\_Value ( m )}$$

For an initial implementation of the Risk Surface assessment formulas, the Defcon value may be a constant across all assets. Thus, the notion of an individual Defcon(m) value is initially irrelevant since every initial Defcon(m) will be the same. Nonetheless, the weighed average formula is included because Defcon values may become machine or asset specific with time. While it may appear that assessments are scaled twice by machine asset value, this is not the case. The use of asset value in these weighted averages does not scale the assessments in an absolute sense, but rather, just serves to give more prominence to certain asset values. First, this is shown by using the asset value as a divisor. Second, this is shown by the independence of the assessment value when there is only one asset. That is, for one asset the assessment value is unaffected by this formula.

According to flow 500, the operation of calculating a final high-level risk surface value in operation 514 may include, for either individual assets or groups of assets, a calculation of the overall Risk ‘surface’ using the area formula:

Rn=((V+A)*(T+E))/36

For calculating an individual asset, the V,A,T,E values are those of the asset (e.g. V(m)). For calculating groups of assets, the V,A,T,E values are the weighed averages values for the groups (e.g. V(g)).

Finally, according to flow 500, the operation of displaying the final risk surface value in operation 516 may include transferring to or reproducing a representation of the calculated risk surface and associated information on a display device or a recording device. The display device can include a color computer monitor (e.g. cathode ray tube, plasma display, a liquid crystal display) or a projection device. The display device can also include forming a permanent representation such printing the final risk surface value on a document. Finally, the display device can include recording the final risk surface value on a recordable medium using a recording device with optical or magnetic media including Compact Disc (CD), a Digital Versatile Disk (DVD), a magnetic tape, or a microfloppy disc, to record and reproduce the risk surface values.

Supporting or operational data for these calculations may include filtered asset ‘populations’ along with corresponding values for nAssets of the filtered group as well as an associated or aggregate criticality. Vector data for each asset in one or more filtered groups may include Risk, Vulnerability, Threat, LackofProtection, AttacksActual, AttacksInferred, Periphery, and/or Audits. Various asset attributes may include nPorts, nShares, nUsers, and/or nServices data for each asset in the filter group. For a particular asset type, other attributes may include MaxPorts, MaxServices, MaxShares, and/or MaxUsers which could initially be mapped as global values, but eventually mapped to a specific asset type. Supporting or operational data may also include ThreatIndex (1 . . . n) values (as many as possible), AssetValue data computed per asset in the filter group or computed by exponentially adjusting the user-set Criticality values, and Protection ratings including an Antivirus rating, a Firewall-Host rating, a Firewall-DMZ rating, an OS-SP-Hotfix rating, a Scan recency rating, and/or a Scan completeness rating.

User or customer/client specific data may be assembled to include a Criticality value for each asset, a set of Risk Comfort Zone values including an upper risk value and a lower risk value for one or more assets, and a set of user ratio values that may be used as parameters for data gathering, filtering, and/or calculation. One or more pie charts may be used to represent a number of assets in different areas of the comfort zone as an aggregation of the risk assessment data, while parameters of the pie charts may be adjusted by a user accessible control panel. Exemplary user ratio values may include userRatioV1, userRatioV2, userRatioShares, userRatioPorts, userRatioUsers, userRatioServices, userRatioT1 . . . userRatioTn, and/or userRatioLP1 . . . userRatioLPn. Thresholds for various weighted averages (“H” values) may also be used.

Briefly in reference to FIG. 3, the predetermined set of instructions to perform the computation, display, and evaluation of a risk surface formulas on computer system 300 may include a library of Application Program Interface (API) routines or protocols that facilitate a proper interface within an operating system running on computer system 300. More specifically, the present invention may be embodied in a computer readable medium on which is stored a computer program for executing one or more method steps according to an embodiment of the present invention.

Particular API routines or calls for individual assert, or leaf nodes, in a network or Spider may include:

```
    vectorValsArray = GetAssetVectors( in: asset_ID, in:
time_period)
    For Asset Filter/Aggregates/Groups, vector_ID
specifications may include:_Risk, Vulnerability, Threat,
LackofProtection, Criticality, AssetValue, Periphery, Audits,
AttacksActual, and/or AttacksInferred, where particular API
calls may include:
    averageVal = GetAssetsVectorAverage( in: attribute_ID, in:
vector_ID, in: time_period)
    nAssets = GetAssetsCount( in: attribute_ID, in: vector_ID,
in: vector_min, in: vector_max)
    maxVal = GetAssetVectorAbsMax ( in: attribute_ID, in:
vector_ID )
    For All Assets globally, a particular API call may include:
    ThreatClimateVal = GetThreatClimate ( in: cve_ID, in:
time_period)
```

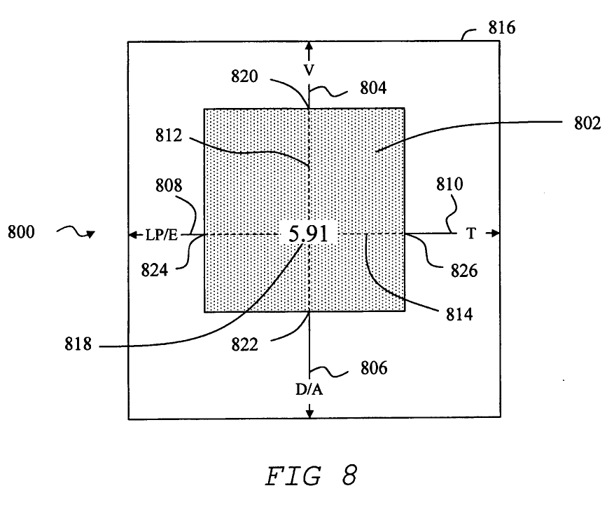

FIG. 8 shows a risk surface graphical element 800, also termed a risk surface 800, comprising a two-dimensional representation of risk in accordance with an embodiment of the present invention. Risk surface 800 has a risk surface area 802 calculated as the area subtended by four normalized vectors (804, 806, 808, and 810) defining different risk factor areas located on a pair of non-parallel and preferably orthogonal lines (812, 814) drawn between the center-points of a square boundary 816. A first normalized vector 804 corresponds to a Vulnerabilities (V) area, a second normalized vector 806 corresponds to an Attacks (D) area, a third normalized vector 808 corresponds to an Exposure (Lack-of-Protection, or LP) area, while a fourth normalized vector 810 corresponds to a Threat (T) area. A vertex 818 corresponds to the intersection of all four normalized vectors (804, 806, 808, and 810) where each normalized vector has a zero length value comprising a zero point. Each of the normalized vectors (V, D, LP, T) has the same meaning as defined in reference to the symbols and equations described in reference to FIGS. 1-4, including risk, risk area, magnitude, raw data generation, processing, criticality, scaling, normalization, color, intensity, size, timeliness, comparative risk.

First orthogonal line 812 is oriented vertically and includes first normalized vector 804 and second normalized vector 806, where first normalized vector 804 is opposite in direction to second normalized vector 806 about zero point 818. Second orthogonal line 814 is oriented horizontally and includes third normalized vector 808 and fourth normalized vector 810, where third normalized vector 808 is opposite in direction to fourth normalized vector 810 about zero point 818. Risk surface 800 intersects each normalized vector at a predetermined point corresponding to a normalized vector value along each normalized vector (804, 806, 808, and 810). In this manner, surface 800 intersects first normalized vector 804 at a first normalized vector value 820 corresponding to a Vulnerabilities (V) vector length value, surface 800 intersects second normalized vector 806 at a second normalized vector value 822 corresponding to an Attacks (D) vector length value, surface 800 intersects third normalized vector 808 at a third normalized vector value 824 corresponding to an Exposure (LP) vector length value, and surface 800 intersects fourth normalized vector 810 at a fourth normalized vector value 826 corresponding to a Threats (T) vector length value. Any of these vectors (V, D, LP, T) may have a zero length. While a particular relationship between adjacent vectors is shown and described, other placements may also be used. Hence, V may be adjacent to both T and E, while being oriented oppositely from A. Similarly, V may be adjacent to both E and A, while being oriented oppositely from T. Any other pairing between these vectors may be used, and may be configured or selected by a user.

First orthogonal line 812 is disposed at a right angle to second orthogonal line 814 so that when at least two adjacent normalized vector values (820, 822, 824, and 826) have a non-zero length value, a non-zero area value for risk surface area 802 will result. The geometric disposition of normalized vector values (820, 822, 824, and 826) can describe a risk surface 800 for a specific network asset or group of assets. Risk surface 800 can be reproduced in any fixed medium including a computer printout or book, or any temporal medium including a graphic user interface (GUI) such as a computer display screen or a projected image. Comparison pane 800 may be displayed using a browser application, such as a web-browser, running on processing unit 302, as shown in FIG. 3.

Returning to FIG. 8, the area covered by the tile 802 may be stated in equation form as:

(V+D)*(LP+T), or alternatively (V+A)*(E+T)

Using a minimum vector length of 0 and a maximum vector length of 9, this would yield a minimum risk for a device or group of devices as 0, and the maximum risk for a device or group of devices as 18*18=324. If the total Risk values are normalized to between 0 and 9 as well, the Risk formula can be modified as:

Rn = (((V + A) * (E + T))/(18 * 18)) = ((V + A) * (T + E))/324
For example, if all vectors are 9, R = (9 + 9) * (9 + 9)/36 = 9.

Alternatively, instead of dividing by 9, a different view may be used that may be used to skew one or more vectors.

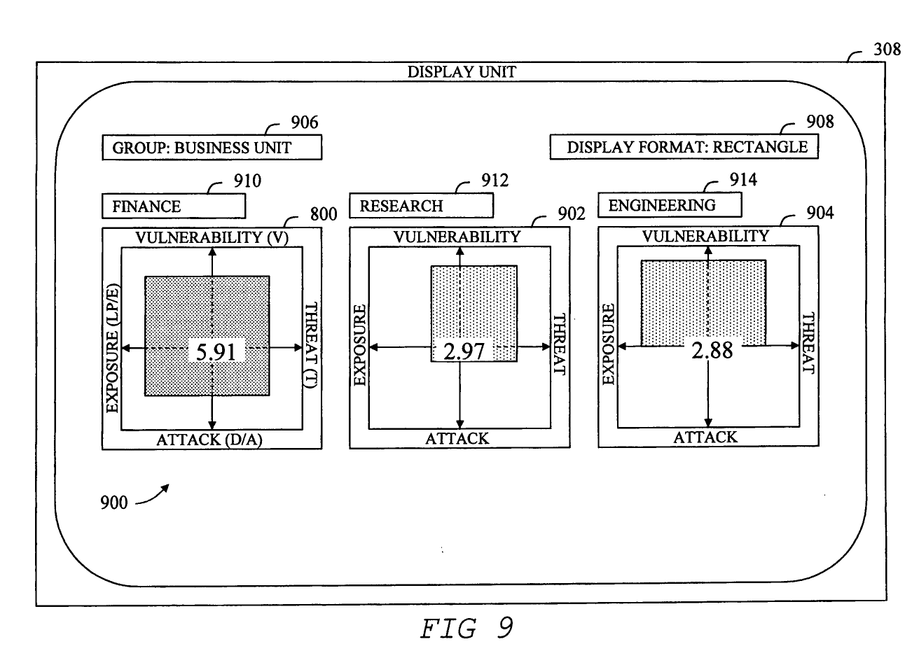

FIG. 9 shows a comparison pane 900 including a plurality of risk surface tiles (800, 902, and 904) where each tile conveys risk information for a concurrent or most recently reported period across a particular group 906 of assets in a particular display format 908. In this exemplary embodiment, comparison pane 900 includes three risk surface tiles associated with group 906 including finance 910 having a risk surface area of 5.91, research 912 having a risk surface area of 2.97, and engineering 914 having a risk surface area of 2.88, where other groups and formats may be displayed. Each of the tiles (800, 910 may include one or more network assets, clusters, or workgroups as described in reference to FIGS. 3-4. The number and position of the risk surface tiles is not limited to that shown. Comparison pane 400 may be displayed using a browser application, such as a web-browser, running on processing unit 302. Similar to the description of FIGS. 1-4, the risk surface depictions of FIGS. 8-9 provide an intuitive visual Risk comparison of different groups or elements. The shape, color, intensity, and center-point of each risk surface may convey information about the risk and/or risk profile of the associated group or element.

Embodiments described above illustrate but do not limit the invention. It should also be understood that numerous modifications and variations are possible in accordance with the principles of the present invention. Accordingly, the scope of the invention is defined only by the following claims.

I claim:

1. A method of computing a risk surface vector, comprising the operations of:
gathering raw assessments;
forming single assessments;
creating asset values;
scaling by asset values;
calculating higher-level assessment formulas per asset;
creating asset-value weighted averages for aggregate groups; and
calculating a final high-level risk surface value.

2. The method of claim 1, wherein the operation of forming single assessments, comprises:
normalizing the plurality of raw assessments to form normalized raw assessments; and
thresholding the raw normalized raw assessments to form a plurality of single assessments.

3. The method of claim 1, wherein the process of creating asset values includes the process of scaling user asset criticality values.

4. The method of claim 3, wherein the process of creating asset values includes an exponentiation of the user asset criticality values, the exponentiation being at least one of base-3.5, base 3, and base-e.

5. The method of claim 3, wherein criticality is factored into each vector.

6. The method of claim 5, wherein criticality is factored in by scaling a predetermined plurality of raw assessments by a predetermined asset value.

7. A method claim 1, further comprising the operation of displaying the final risk surface value, the operation of displaying the final risk surface value including at least one of:
displaying the final risk surface value on a computer monitor;
printing the final risk surface value on a document; and
recording the final risk surface value on a recordable medium.

8. A risk surface graphical element providing a two-dimensional representation of risk, comprising:
four normalized vectors disposed on two non-parallel lines, each normalized vector defining a risk factor area, a crossing point of the two orthogonal lines defining a zero point for each of the four normalized vectors, a risk factor vector length corresponding to a distance from the zero point so that a non-zero vector length for at least two adjacent vectors describes a risk surface having a risk surface area value.

9. The risk surface graphical element of claim 8, wherein a first normalized vector corresponds to a network asset vulnerabilities (V) area.

10. The risk surface graphical element of claim 8, wherein a second normalized vector corresponds to a network asset attacks (A) area.

11. The risk surface graphical element of claim 8, wherein a third normalized vector corresponds to a network asset exposure (E) area.

12. The risk surface graphical element of claim 8, wherein a fourth normalized vector corresponds to a network asset threat (T) area.

13. The risk surface graphical element of claim 8,
wherein a first normalized vector corresponding to a network asset vulnerabilities (V) area and a fourth normalized vector corresponding to a network asset threat (T) area are oriented in opposite directions on a first line, and
wherein a second normalized vector corresponding to a network asset attacks (A) area and a third normalized vector corresponding to a network asset exposure (E) area are oriented in opposite directions on a second line, the first line being orthogonal to the second line.

14. The risk surface graphical element of claim 8,
wherein a first normalized vector corresponding to a network asset vulnerabilities (V) area and the second normalized vector corresponding to a network asset attacks (A) area are oriented in opposite directions on a first line, and
wherein the third normalized vector corresponding to a network asset exposure (E) area and the fourth normalized vector corresponding to a network asset threat (T) area are oriented in opposite directions on a second line, the first line being orthogonal to the second line.

15. A risk surface tile element providing a two-dimensional representation of risk, comprising:
a risk surface graphical element;
an attribute type icon;
an attribute type field; and
an attribute value.

16. The risk surface tile element of claim 15, wherein the attribute icon includes a representation of a number of assets in the group and an aggregated criticality factor.

17. The risk surface tile element of claim 15, further comprising:
an information button configured to provide access to a detailed data breakdown of one or more risk vectors.

18. A risk assessment system, comprising:
a display device configured to display information to a user; and
a plurality of risk surface tiles reproduced on the display device, each risk surface tile being configured to display a risk assessment for a predetermined network resource at a predetermined time, a computation for each risk surface vector comprising the operations of:
gathering raw assessments;
forming single assessments;
creating asset values;
scaling by asset values;
calculating higher-level assessment formulas per asset;
creating asset-value weighted averages for aggregate groups; and
calculating a final high-level risk surface value.

19. The risk assessment system of claim 18, further comprising:
a computer processor configured to fetch, decode, and execute a computer program including instructions to at least one of compute each risk surface vector comprising the risk surface tile, and display the computed risk surface tile on the display device.

20. A computer readable medium on which is stored a computer program for executing the following instructions:
gathering raw assessments;
forming single assessments;
creating asset values;
scaling by asset values;
calculating higher-level assessment formulas per asset;
creating asset-value weighted averages for aggregate groups; and
calculating a final high-level risk surface value.
